(19) United States
(12) Patent Application Publication
(10) Pub. No.: US 2020/0043358 A1
(43) Pub. Date: Feb. 6, 2020

(54) NON-INVASIVE CONTROL APPARATUS AND METHOD FOR HUMAN LEARNING AND INFERENCE PROCESS AT BEHAVIORAL AND NEURAL LEVELS BASED ON BRAIN-INSPIRED ARTIFICIAL INTELLIGENCE TECHNIQUE

(71) Applicant: Korea Advanced Institute of Science and Technology, Daejeon (KR)

(72) Inventors: Sang Wan Lee, Daejeon (KR); JeeHang Lee, Daejeon (KR)

(73) Assignee: Korea Advanced Institute of Science and Technology, Daejeon (KR)

(21) Appl. No.: 16/352,312

(22) Filed: Mar. 13, 2019

(30) Foreign Application Priority Data
Jul. 31, 2018 (KR) 10-2018-0089186

(51) Int. Cl. G09B 19/00; G06N 3/08

(52) U.S. Cl. CPC G09B 19/00; G06N 3/08

(57) ABSTRACT

Disclosed are a non-invasive control method and system for a human learning and inference process at behavioral and neural levels using a brain-inspired artificial intelligence technique. The non-invasive control system may transplant a model, designed in relation to a user's learning and inference, into artificial intelligence and training the user's behavior for knowledge data through a reinforcement learning agent, and may control task variables related to the user's learning and inference for the knowledge data based on the learning mechanism of the user derived based on the trained user's behavior.

### CROSS REFERENCE TO RELATED APPLICATION

This application is based on and claims priority under 35 U.S.C. 119 to Korean Patent Application No. 10-2018-0089186, filed on Jul. 31, 2018, in the Korean Intellectual Property Office, the disclosures of which is herein incorporated by reference in their entireties.

### BACKGROUND OF THE INVENTION

### 1. Technical Field

The following description relates to a method and system for noninvasively controlling a human learning and inference process based on an artificial intelligence technique. This work was supported by Samsung Research Funding Center of Samsung Electronics under Project Number SRFC-TC1603-06.

### 2. Description of the Related Art

The current development of the artificial intelligence technique is concentrated on the assistance and replacement of human's tasks, such as video/voice recognition, process optimization, translation, speaking, and robot control. As a next step of research for replacing or assisting the human's task, if a technique for maximizing the human's knowledge processing ability itself using artificial intelligence is implemented, the human and artificial intelligence may interact (or coevolve) with each other at a deeper level. There are attempts to improve the human's task ability using artificial intelligence, but such approach methods have the following fundamental technical limits.

A conventional curriculum learning technique is aimed at how the learning effect can be improved when a user performs learning using a computer by rearranging leaning data in which sequence. The conventional technique includes performing observation using multiple modalities, such as learning effects, attitude and a learning progress, through an interaction with a user, generating an intrinsic model for personal performance based on the multiple modalities, and then rearranging/configuring leaning data based on the generated model. In this technique, a base mechanism of the human's cognitive function is basically assumed to be a black box and the human's learning mechanism is inferred based on the observation of a system. In other words, in the conventional technique, the system provides learning data that has been modified/arranged as a reaction with respect to a learner's behavior. Furthermore, methods based on the conventional technique and artificial intelligence engine disclose only theoretical artificial intelligence contents only, but do not include a technique (e.g., model or algorithm) for an optimal learning data configuration and do not have a method for an optimal learning model proposal and technical configuration for maximizing the learning effect.

Furthermore, a conventional approach method of forming an optimal model based on the user learning history does not precisely estimate the human's suboptimal learning and inference process and does not taken into consideration a brain process involved in the execution of the human's task.

### SUMMARY OF THE INVENTION

There can be provided a system and method for noninvasively controlling the user's learning and inference ability at behavioral and neural levels using state-of-the-art brain-inspired artificial intelligence technique.

There can be provided a non-invasive control system and method for eliciting the desirable state of human's learning and inference process themselves through both the interactions with the users, and the non-invasive control of learning and inference-related variables which are processed at a neural level.

A control method of user's learning and inference performed by a noninvasive control system may include training users behavior on knowledge data through an reinforcement learning agent whose artificial intelligence is transplanted from a computational brain model user's learning and inference process in the brain, and controlling task variables related to the user's learning and inference for the knowledge data based on the learning mechanism of the user derived based on the trained user's behavior aforementioned.

Controlling task variables related to the user's learning and inference may include reconfiguring, by the reinforcement learning agent, the knowledge data as knowledge content by rearranging the knowledge data based on an objective function for configuring the speed of the user's learning and inference. The objective function may be configured based on the basal ganglia in the human brain and a learning and inference signal and characteristics of the user generated at a neural signal level.

Controlling task variables related to the user's learning and inference may include predicting the learning mechanism of the user as the learning and inference for the reconfigured knowledge content is tested with respect to the user.

Controlling task variables related to the user's learning and inference may include providing a sequence of knowledge content arranged based on the predicted learning mechanism of the user.

Controlling task variables related to the user's learning and inference may include computing exposure frequency for each knowledge set semantically and syntactically analyzed within the knowledge content generated based on the learning mechanism of the user, and computing the connectivity of each knowledge set.

Controlling task variables related to the user's learning and inference may include noninvasively stimulating a brain area responsible for the user's learning and inference by providing knowledge content based on the learning mechanism of the user and an interaction.

A non-invasive control system includes reinforcement learning agent configured to transplant a model, designed in relation to a user's brain-inspired learning and inference discovered in the user's brain, into artificial intelligence. The reinforcement learning agent may process a process of training the user's behavior for knowledge data and a process of controlling task variables related to the user's learning and inference for the knowledge data based on the learning mechanism of the user derived based on the trained user's behavior.

The reinforcement learning agent may reconfigure the knowledge data as knowledge content by rearranging the knowledge data based on an objective function for configuring the speed of the user's learning and inference. The objective function may be configured based on the basal ganglia in the user's brain and a learning and inference signal and characteristics of the user generated at a neural signal level.

The reinforcement learning agent may predict the learning mechanism of the user as the learning and inference for the reconfigured knowledge content is tested with respect to the user.

The reinforcement learning agent may provide a sequence of knowledge content arranged based on the predicted learning mechanism of the user.

The reinforcement learning agent may compute exposure frequency for each knowledge set semantically and syntactically analyzed within the knowledge content generated based on the learning mechanism of the user, and may compute the connectivity of each knowledge set.

The reinforcement learning agent may noninvasively stimulate a brain area responsible for the user's learning and inference by providing knowledge content based on the learning mechanism of the user and an interaction.

### BRIEF DESCRIPTION OF THE DRAWINGS

FIGS. 1 and 2 are diagrams illustrating a general operation of designing a brain process model in relation to a user's learning and inference and transplanting the designed model into artificial intelligence in a non-invasive control system according to an embodiment.

FIG. 3 is a diagram for illustrating a non-invasive control operation for a user's learning and inference process in the non-invasive control system according to an embodiment.

FIGS. 4 and 5 are diagrams for illustrating a non-invasive control operation for a user's learning and inference process at behavioral/neural levels based on an artificial intelligence technique in the non-invasive control system according to an embodiment.

FIG. 6 is a diagram for illustrating a knowledge structured process for a user's learning and inference in the non-invasive control system according to an embodiment.

FIG. 7 shows an example of a user's learning inference process at behavioral and neural levels of the user using brain-inspired artificial intelligence in the non-invasive control system according to an embodiment.

FIG. 8 is a flowchart for illustrating a method of providing a sequence of knowledge content in the non-invasive control system according to an embodiment.

FIG. 9 is a flowchart for illustrating a method of generating a model for learning and inference in the non-invasive control system according to an embodiment.

### DETAILED DESCRIPTION

Hereinafter, embodiments are described in detail with reference to the accompanying drawings.

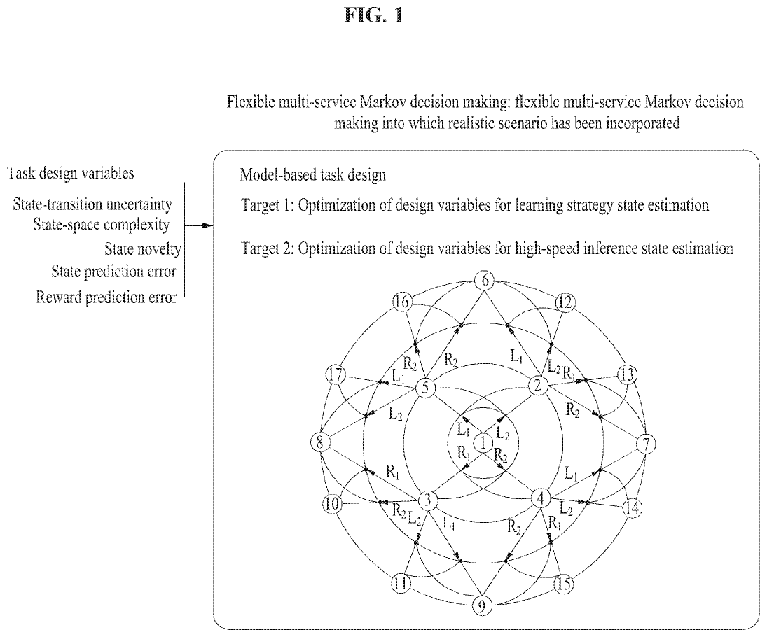

FIG. 1 is a diagram for illustrating a general operation of designing a brain process model in relation to a user's learning and inference and transplanting the designed model into artificial intelligence in a non-invasive control system according to an embodiment.

The non-invasive control system is based on a convergence technique of computational neuroscience-artificial intelligence for designing a neural model related to a user's learning and inference using a model-based rain experiment scheme and transplanting the designed neural model in an artificial intelligence algorithm form. In this case, the computational model-based brain experiment is defined as follows. After a mathematical, statistical model is constructed based on a user's behavior data appearing when a specific task is performed, a brain image captured by fMRI using the generated computational model may be analyzed and a brain function/mechanism may be investigated. The computational model provides information so that the brain activities of a user can be estimated from behavior data, and is also called a computational brain model because the model is considered to describe a brain function/mechanism according to a specific task. If such a computational model is used, which area is activated when a task is performed can be estimated based on an fMRI image captured while a user performs a specific task.

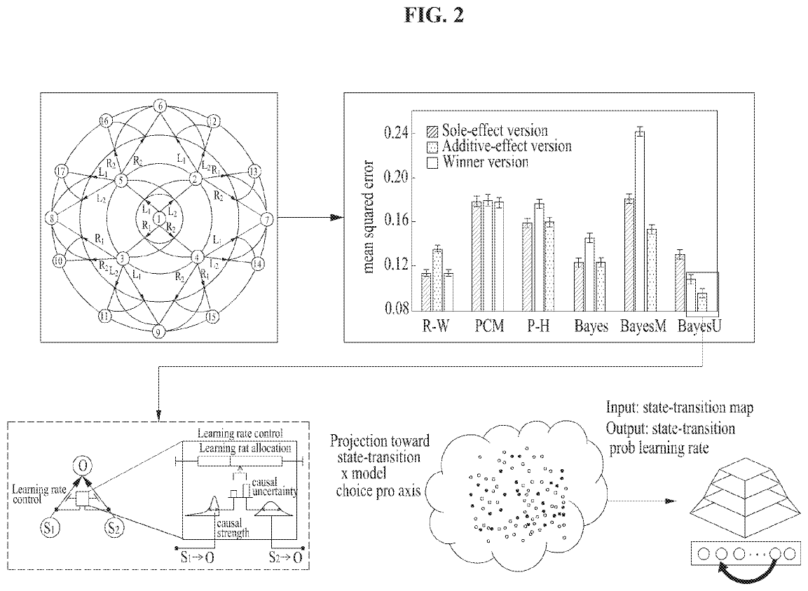

A detailed operation of designing a model related to a user's learning and inference and transplanting the designed model into artificial intelligence is described below with reference to FIG. 2. The non-invasive control system may perform a consecutive high-speed inference task design process (Multi-stage MDP), a model-based fMRI process, a virtual brain process, a virtual data set generation process, and an observation process. The operation of designing a model related to a user's learning and inference and transplanting the designed model into artificial intelligence is not limited to FIG. 2. FIG. 2 is described an example in order to help convenience of description.

The consecutive high-speed inference task design process is performed as follows. In order to construct a model that describes a human's learning and inference process, there is a need for a task capable of identifying a user's high-speed/repetition learning and inference process. A user's behavior task may be designed by considering task design variables into which a scenario has been incorporated because a behavior and brain function/mechanism may be precisely discovered according to the elaboration of the task. Behavior experiments may be performed using the designed behavior task. A model for the behavior task (e.g., computational (brain) model) for confirming the corresponding task (e.g., high-speed learning and inference) may be derived based on the results of the experiments.

The model-based fMRI process is a process of estimating and confirming a brain function mechanism accompanied when a specific task is performed using a derived model (e.g., computational (brain) model). Accordingly, how the model successfully models a user's behavior and the base brain mechanism can be confirmed.

In the virtual brain process, the model derived through the above-described process describes a brain function/mechanism for controlling and decision-making behaviors in addition to the user's behavior, and may connect, interpret and describe a brain function for behavior data. In particular, in embodiments, the model may provide a virtual brain process for learning and inference.

The virtual data set generation process may be used to generate a virtual behavior data, brain function/mechanism and brain-inspired learning and inference degree using the most important characteristics reproduced with respect to a common user's learning and inference through a virtual brain process.

The observation process may be used to observe a learning and inference state through an observer (I-Observer). A behavior for a user's learning and inference may be received, a brain area/function/mechanism for currently activated learning and inference may be inferred, and a degree of brain activities for the learning and inference may be derived. A model for learning and inference can be constructed and proven through the above-described process and a virtual brain process is implemented. Various data can be collected based on a virtual behavior-brain function-brain function degree that may be shown by a user using such a process. Accordingly, an artificial intelligence algorithm can be generated using such a model, and artificial intelligence may be trained using the virtual data. In this case, an observer capable of observing and determining a user's learning and inference state can be generated based on a deep learning model trained by the virtual brain process and the virtual data set generation process and a consecutive high-speed inference task.

If the observer is used, how a user's brain process is revealed, how a function is revealed to which degree, and which region (and/or a function corresponding to the region) is activated or deactivated can be confirmed by only observing the user's behavior. Furthermore, task variables that are now performed can be adjusted using at least one of a current brain region, the brain function or the activation degree. Accordingly, a brain region, a brain function and an activation degree can be derived. For example, after a brain region, a function and an activation degree are estimated by observing the current state and precisely controlling designed task variables, a user's learning and inference strategy can be further activated by adjusting the task or a weak part can be approached as the meaning of cognitive rehabilitation by further activating the weak part and a user may be assisted to perform an optimal learning and inference strategy by noninvasively controlling an excessively activated part.

The non-invasive control system may be precisely aware of a user's learning and inference state and may precisely estimate where the learning strategy is concentrated, for example, the precise estimation of a brain function/region/degree.

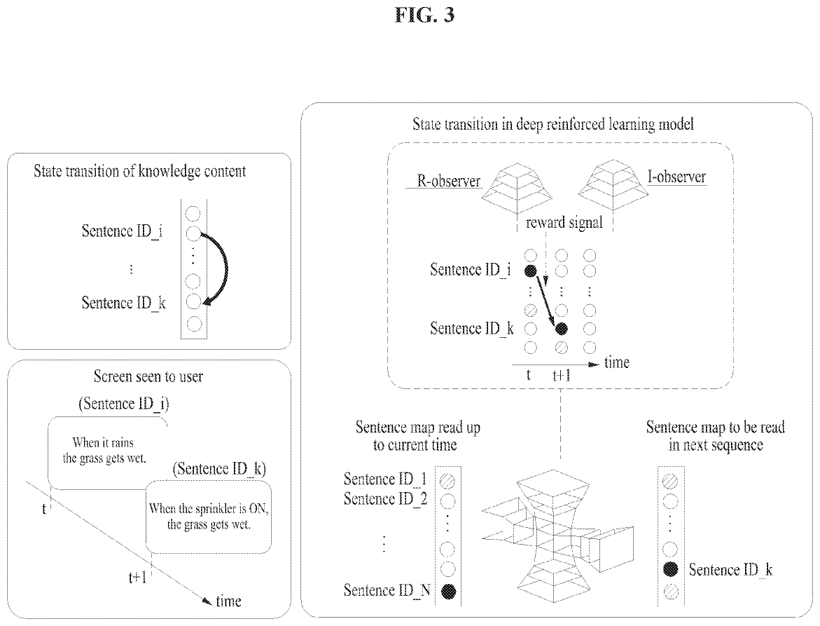

FIG. 3 is a diagram for illustrating a non-invasive control operation for a user's learning and inference process in the non-invasive control system according to an embodiment.

The noninvasive control system may train a reinforcement learning agent using a high-speed inference strategy discovered in the brain of a user, may search for a sequence of knowledge in which high-speed learning is performed when the new knowledge is provided to the reinforcement learning agent, and may provide the user with the rearranged sequence. Accordingly, the user may be derived to obtain the high-speed knowledge.

For example, referring to the state transition part of knowledge content of FIG. 3, in general, a user may perform learning in such a way as to read knowledge data (e.g., sentence) ‘sequentially”, return to a knowledge piece that, has not been certainly learnt if necessary, and repeatedly read corresponding knowledge piece. Referring to a screen displayed to the user of FIG. 3, the noninvasive control system may sequentially present knowledge data, and the user may perform a process of reading the listed knowledge data and performing learning.

It is assumed that the reinforcement learning agent can predict and present knowledge/information piece that may be most effectively learnt when it analyzes user's knowledge learning history so far and reads it in a next sequence. Referring to a state transition part in the deep reinforcement learning model of FIG. 3, a user's learning performance may be more effective than performance through known sequential learning. If approximate reinforcement learning based on deep learning is trained by a user's brain function model and this trained artificial intelligence confirms a personal learning strategy, rearranges knowledge data in such a way as to maximize each learning ability, and provides the knowledge data to the user, a presented content and array sequence may activate a specific part of the brain to derive high-speed learning, thus being capable of improving an overall learning ability. Specifically, according to the model, repeatedly presented knowledge data has less brain resources allocated to learning because the uncertainty of the knowledge is relatively low. In contrast, less presented knowledge data has more brain resources allocated to learning because the uncertainty of the knowledge is relatively high, which is called a learning rate. In this case, a higher learning rate is assigned as the certainty of knowledge is higher, and a lower learning rate is assigned as the certainty of knowledge is lower. In embodiments, a deep learning-based approximate reinforcement learning model for maximizing the learning rate. The constructed model may search for an optimal knowledge arrangement in which knowledge data (e.g., text data, image data) could be given to the users always with a certain degree of a learning rate allocated at a level of a preset reference or more.

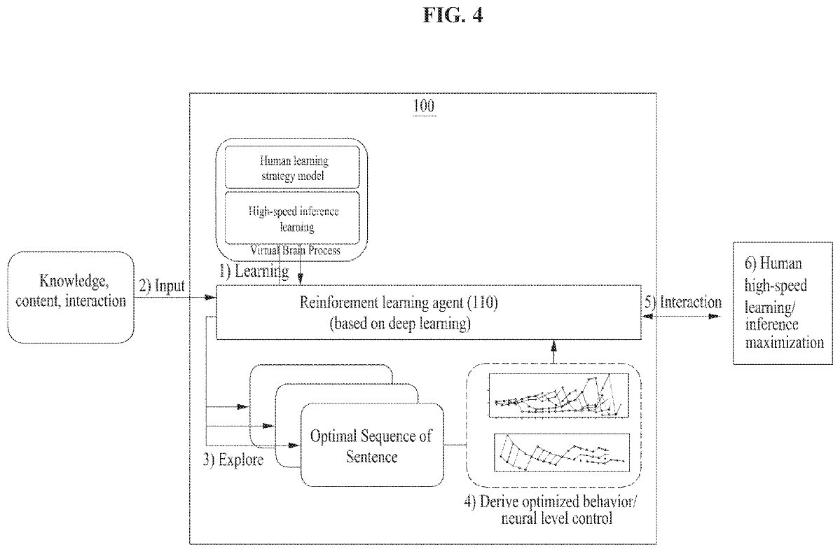

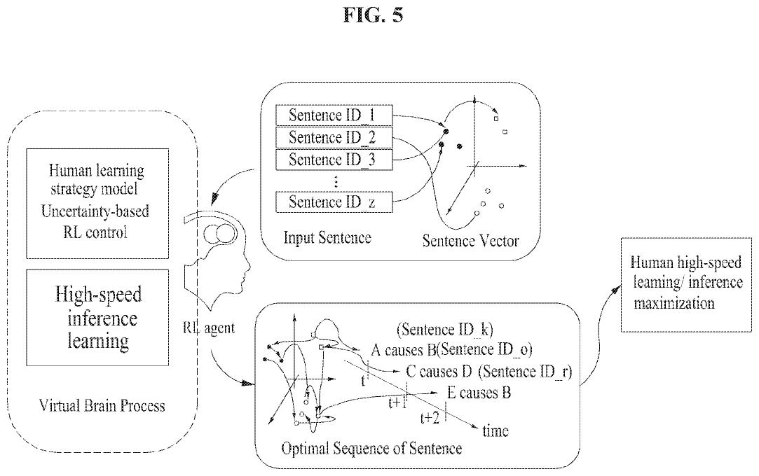

FIGS. 4 and 5 are diagrams for illustrating a noninvasive control operation for a user's learning and inference process at behavioral/neural levels based on an artificial intelligence technique in the noninvasive control system according to an embodiment.

The non-invasive control system 100 may be implemented in a form of artificial intelligence and used in all situations in which a user interacts with a computer. The noninvasive control system may be provided in an internal component form of a user-computer interaction system to maximize a user's learning and inference ability itself at behavioral and neural levels. The system may operate in each computer itself interacting with a user and may also operate in a separate server system form. Furthermore, at least one element (or system) is combined with the non-invasive control system to interact with a user and to noninvasively control learning and inference-related variables processed at a neural level. Accordingly, there can be provided a control technique in which the non-invasive control system derives a user's learning and inference process itself in a desired state.

For example, a system 1 may design a brain process model in relation to a user's learning and inference and transplant the model into artificial intelligence. The system may design a neural model related to a user's learning and inference using a model-based brain experiment scheme, and may transplant the designed neural model in an artificial intelligence algorithm form. The system 1 enables a model design not dependent on the type of task because it is based on a computational neuroscience-artificial intelligence convergence technique and handles a brain process that forms the base of a user's learning and inference process.

A system 2 may noninvasively control user's learning and inference process. The system may noninvasively control variables related to learning and inference processed at a neural level, and may derive a user's learning and inference process in a desired state. The system 2 is based on an artificial intelligence-game theory-control convergence technique, and may use the process of the system 1 as a virtual state observer. The system 2 may derive a maximum learning effect even with minimum observation and learning time. An operation for the non-invasive control system according to an embodiment to control a user's learning and inference process based on a form in which such as system has been combined is described below.

The non-invasive control system 100 may transplant a model, designed in relation to a user's learning and inference, into a reinforcement learning agent 110 based on deep learning, and may train the reinforcement learning agent 110. For example, the non-invasive control system 100 may transplant a brain-inspired knowledge high-speed inference model, discovered in the brain of a user, into the reinforcement learning agent 110. In the brain-inspired knowledge high-speed inference model, user's learning efficiency of a specific knowledge set may be defined as a learning rate. Knowledge needs to be frequently exposed to a brain so that the uncertainty of knowledge is greatly reduced although the brain performs learning once by allocating many brain resources when the brain learns the knowledge having a high learning rate and that the uncertainty of knowledge is reduced by allocating small brain resources whenever the brain is exposed to knowledge once when the brain learns the knowledge having a low learning rate.

The non-invasive control system 100 may compute exposure frequency for each knowledge set analyzed within knowledge data semantically and syntactically, may compute knowledge data that appears relatively less or once by comparing the computed knowledge set with a group of knowledge sets repeated with a preset reference or more, as a knowledge connectivity, and may provide the knowledge connectivity as an environment for the approximate reinforcement learning agent 110. The reinforcement learning agent 110 may perform training by setting that a maximum learning rate can be provided to each knowledge set as an objective function. In other words, the non-invasive control system may generate a policy capable of minimizing the uncertainty of a knowledge set with a maximum learning effect, that is, the least search number, whenever it searches for one knowledge set once. The reinforcement learning agent 110 trained as described above may analyze, structure and rearrange knowledge data in such a way as to derive brain high-speed inference, and may provide the knowledge data. Accordingly, knowledge learning performance can be significantly improved even with less repetition and less learning time. In this case, the knowledge data does not need to have a specific form and may have any form if it can be converted into a form that can be computed.

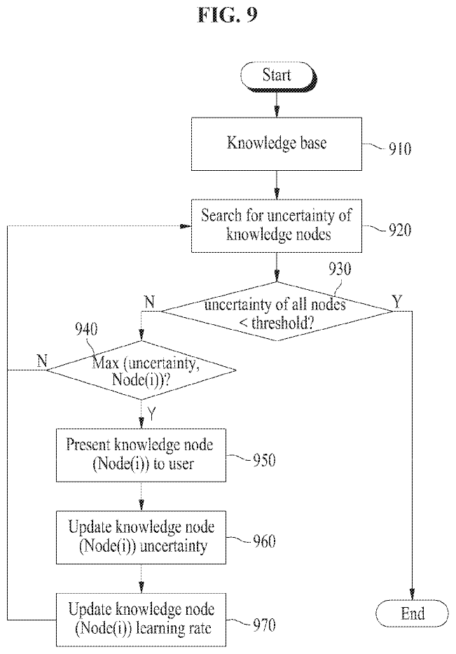

The reinforcement learning agent of the non-invasive control system may train a model related to a user's learning and inference. FIG. 9 is a flowchart for illustrating a method of generating a model for learning and inference in the non-invasive control system according to an embodiment. For example, assuming that three knowledge sets S1, S2 and S3 are present in a knowledge base 910, the knowledge sets S1 and S2 frequently appear with a preset reference or more, and the knowledge set S3 less appears with the preset reference or less, three types of probability distributions, for example, (in this case, Dirichlet) may be defined as follows.

Dir(α₁, α₂, α₃)

In this equation, αᵢ=λᵢ+xᵢ is considered to be the number of times that Si may appear. In such setting, when a user views each knowledge set, the mean and variance of posterior related to the learning of the knowledge set may be derived as follows.

$$E ( {θ}_{i} \vert D ) = \frac{{α}_{i}}{{α}_{0}} and Var ( {θ}_{i} \vert D ) = \frac{{α}_{i} ( {α}_{0} - {α}_{i} )}{{α}_{0}^{2} ( {α}_{0} + 1 )} , i = 1 , 2 , 3.$$

In this equation, a variance value of posterior for each knowledge set may be considered to be a value indicative of learning information of corresponding knowledge at a brain level. In this case, the value is represented as the uncertainty of corresponding knowledge.

After the uncertainty of each knowledge set is computed, a learning rate assigned to a current knowledge set may be computed based on the computed uncertainty (920, 930). For example, when the uncertainty of all knowledge sets is smaller than a threshold, the process may be terminated. When the uncertainty of some knowledge set is equal to or greater than the threshold after the uncertainty of all the knowledge sets is determined, a knowledge set having a maximum uncertainty may be presented to a user (940, 950). The uncertainty of the knowledge set presented to the user is updated as the knowledge set is subject to learning and inference, and a learning rate may be computed (960, 970).

A value of the learning rate may be derived through the following equation.

$${γ}_{i} = \frac{exp ( τ Var ( {θ}_{i} \vert D ) )}{{\sum }_{j} exp ( τ Var ( {θ}_{j} \vert D ) )}$$

When the learning rate of each knowledge set is computed, each learning rate may be combined after a subsequent knowledge set appears, and how the number of appearances affects actual learning may be computed. This may be applied to dispersion again, and the learning rate may be dynamically computed based on a user and a learning change and assigned. The reinforcement learning agent may reconfigure a knowledge set in such a way as to maximize the learning rate whenever each knowledge set appears using such a model as an objective function, and may provide learning data.

FIG. 5 is a diagram for illustrating a detailed operation of the non-invasive control system.

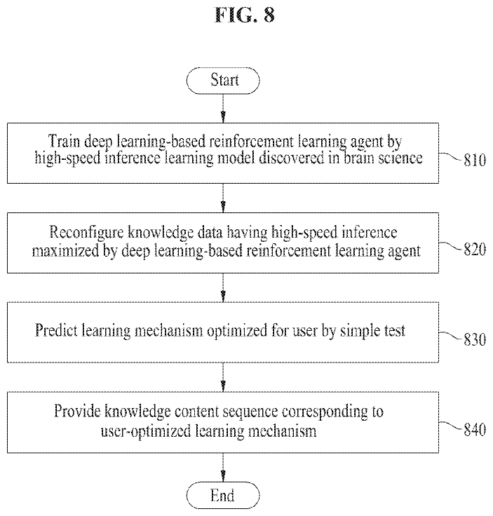

Referring to FIG. 8, the reinforcement learning agent may reconfigure knowledge content having maximized high-speed inference with respect to knowledge data (810). The reinforcement learning agent may reconfigure knowledge data as knowledge content by rearranging the knowledge data based on an objective function for setting the speed of a user's learning and inference. For example, the reinforcement learning agent may reconfigure the knowledge content having maximized high-speed inference (820). The reinforcement learning agent may predict a learning mechanism optimized for the user by testing the user with respect to the reconfigured knowledge content (830). The reinforcement learning agent may provide a sequence by rearranging the knowledge content based on the optimal learning mechanism obtained from the user (840). The reinforcement learning agent may noninvasively stimulate a brain area responsible for the user's learning and inference by providing knowledge content and an interact ion based on the user's learning mechanism.

The non-invasive control system may interact with content to enable high-speed learning and inference using an artificial intelligence technique trained by a user's high-speed learning and inference model discovered in the neuroscience, may predict a learning and inference ability optimized for the user, and may proactively provide optimized content through an interaction proposed by a virtual brain.

The non-invasive control system may noninvasively stimulate a variable/brain area responsible for learning and inference processed at a neural level, and may derive a user's high-speed learning and inference process itself in a desired state at a brain level.

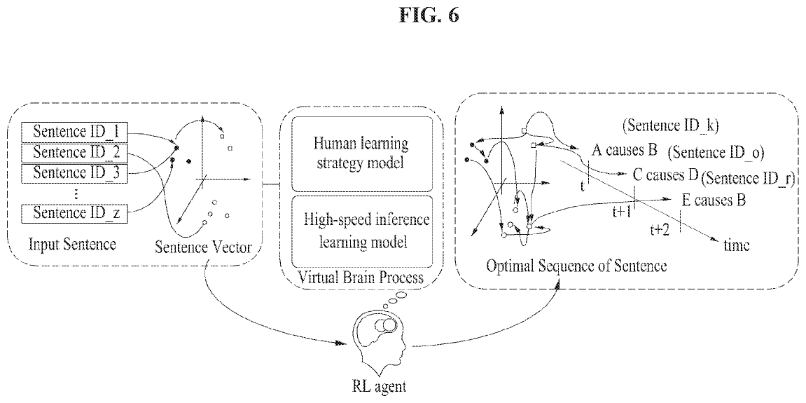

FIG. 6 is a diagram for illustrating a knowledge structured process for a user's learning and inference in the non-invasive control system according to an embodiment. FIG. 6 shows an example of a knowledge structured process for knowledge data. Knowledge data to be learnt by a user may be structured in a form in which the knowledge data can be computed. Such a knowledge structured process is as follows. A sentence set included in knowledge data configured in a natural language may be converted into ontology from which relation inference is possible using an ontology-based knowledge structured engine (e.g., Ollie). The sentence set of the knowledge data converted in the ontology form may be mapped to the space that may be computed. For example, the sentence set converted into the ontology form may be mapped to the space that may be computed using a vectorization scheme, for example, TransE. After extracting a group containing major numbers of ontologies and a novel ontology group, the whole extracted groups may be used as input to the non-invasive control system.

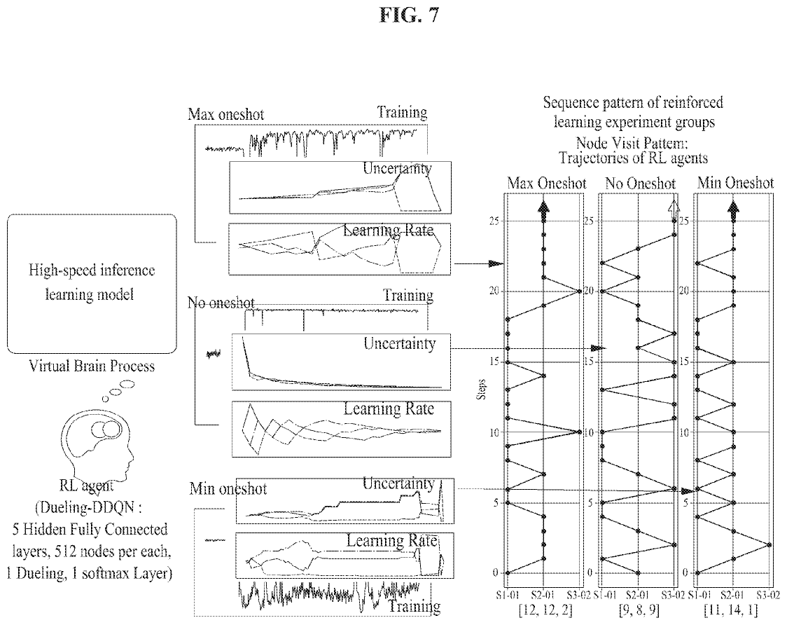

Referring to FIG. 7, a knowledge set that represents three cause-and-effect relationships may be configured. Two (1: S1→O1, 2: S2→O1) of the three cause-and-effect relationships may be set as repeated knowledge, the remaining one (3: S3→O2) may be set as knowledge that appears once.

The reinforcement learning agent may train knowledge data using the high-speed inference model. For example, the reinforcement learning agent may train knowledge data using an objective function for maximizing a high-speed inference effect, an objective function for minimizing a high-speed inference effect and/or an objective function for an incremental learning effect without an effect of high-speed inference. In this case, the reinforcement learning agent may be driven by a plurality of agents having different objective functions or may be driven by one agent that configures different objective functions. A different optimal knowledge sequence having a different effect may be derived by each different objective function. FIG. 7 shows a sequence pattern of each reinforcement learning agent. FIG. 7 shows a knowledge sequence based on the objective function having an incremental learning effect, a knowledge sequence based on the objective function for maximizing a high-speed inference effect, and a knowledge sequence based on the objective function for minimizing a high-speed inference effect from the left.

In addition, all of prices of information represented in the cause-and-effect relationship may be applied to the non-invasive control system. For example, when all of the prices of information are applied to a diagnosis support system capable of providing services, such as a medical disease diagnosis and treatment method, symptom necessary for diagnosis, a disease mechanism, a treatment method related to prognosis and side effects, can be rapidly trained, and decision-making may be rapidly derived to be performed. For another example, a case law or precedent may be rapidly obtained and may be trained in association with the most similar or proper legal information, thereby being capable of deriving decision-making for raising rapid performance accuracy of a legal decision. For yet another example, when all of the prices of information are applied to a system that proposes an online emergency handling manual, manual users can confirm the contents of the manual rapidly and easily and well informed with high learning efficiency.

The above-described apparatus may be implemented as hardware component, a software component and/or a combination of them. For example, the apparatus and components described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing apparatus may perform an operating system (OS) and one or more software applications executed on the OS. Furthermore, the processing apparatus may access, store, manipulate, process and generate data in response to the execution of software. For convenience of understanding, one processing apparatus has been illustrated as being used, but a person having ordinary skill in the art may understand that the processing apparatus may include a plurality of processing elements and/or a plurality of types of processing elements. For example, the processing apparatus may include a plurality of processors or a single processor and a single controller. Furthermore, other processing configurations, such as a parallel processor, are also possible.

Software may include a computer program, code, an instruction or a combination of one or more of them and may configure the processing apparatus to operate as desired or may instruct the processing apparatus independently or collectively. Software and/or data may be embodied in any type of a machine, component, physical device, virtual equipment, computer storage medium or device in order to be interpreted by the processing apparatus or to provide an instruction or data to the processing apparatus. Software may be distributed to computer systems connected over a network and may be stored or executed in a distributed manner. Software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may have been known to those skilled in the computer software. The computer-readable recording medium includes a hardware device specially configured to store and execute the program instruction, for example, magnetic media such as a hard disk, a floppy disk and a magnetic tape, optical media such as CD-ROM and a DVD, magneto-optical media such as floptical disk, ROM, RAM, and flash memory. Examples of the program instruction may include high-level language code executable by a computer using an interpreter in addition to machine-language code, such as code written by a compiler.

A user's knowledge learning performance can be significantly improved even with less repetition and less learning time.

A variable/brain area responsible for learning and inference processed at a neural level can be noninvasively stimulated, and a user's high-speed learning and inference process itself can be derived in a desired state at a brain level.

As described above, although the embodiments have been described in connection with the limited embodiments and drawings, those skilled in the art may modify and change the embodiments in various ways from the description. For example, proper results may be achieved although the above-described descriptions are performed in order different from that of the described method and/or the above-described elements, such as the system, configuration, device, and circuit, are coupled or combined in a form different from that of the described method or replaced or substituted with other elements or equivalents.

Accordingly, other implementations, other embodiments, and equivalents of the claims belong to the scope of the claims.

What is claimed is:

1. A non-invasive control method performed by a non-invasive control system, comprising:
transplanting a model, designed in relation to a user's learning and inference, into artificial intelligence and training the user's behavior for knowledge data through a reinforcement learning agent; and
controlling task variables related to the user's learning and inference for the knowledge data based on a learning mechanism of the user derived based on the trained user's behavior.

2. The method of claim 1, wherein:
controlling task variables related to the user's learning and inference comprises reconfiguring, by the reinforcement learning agent, the knowledge data as knowledge content by rearranging the knowledge data based on an objective function for configuring a speed of the user's learning and inference, and
the objective function is configured based on basal ganglia in the brain of the user and a learning and inference signal and characteristics of the user generated at a neural signal level.

3. The method of claim 2, wherein controlling task variables related to the user's learning and inference comprises predicting the learning mechanism of the user as the learning and inference for the reconfigured knowledge content is tested with respect to the user.

4. The method of claim 3, wherein controlling task variables related to the user's learning and inference comprises providing a sequence of knowledge content arranged based on the predicted learning mechanism of the user.

5. The method of claim 2, wherein controlling task variables related to the user's learning and inference comprises:
computing exposure frequency for each knowledge set semantically and syntactically analyzed within the knowledge content generated based on the learning mechanism of the user, and
computing a connectivity of each knowledge set.

6. The method of claim 1, wherein controlling task variables related to the user's learning and inference comprises noninvasively stimulating a brain area responsible for the user's learning and inference by providing knowledge content based on the learning mechanism of the user and an interaction.

7. A non-invasive control system, comprising:
a reinforcement learning agent configured to transplant a model, designed in relation to a user's brain-inspired learning and inference discovered in the user's brain, into artificial intelligence,
wherein the reinforcement learning agent processes:
a process of training the user's behavior for knowledge data; and
a process of controlling task variables related to the user's learning and inference for the knowledge data based on a learning mechanism of the user derived based on the trained user's behavior.

8. The non-invasive control system of claim 7, wherein:
the reinforcement learning agent reconfigures the knowledge data as knowledge content by rearranging the knowledge data based on an objective function for configuring a speed of the user's learning and inference, and
the objective function is configured based on basal ganglia in the brain of the user and a learning and inference signal and characteristics of the user generated at a neural signal level.

9. The non-invasive control system of claim 8, wherein the reinforcement learning agent predicts the learning mechanism of the user as the learning and inference for the reconfigured knowledge content is tested with respect to the user.

10. The non-invasive control system of claim 9, wherein the reinforcement learning agent provides a sequence of knowledge content arranged based on the predicted learning mechanism of the user.

11. The non-invasive control system of claim 8, wherein the reinforcement learning agent computes exposure frequency for each knowledge set semantically and syntactically analyzed within the knowledge content generated based on the learning mechanism of the user, and computes a connectivity of each knowledge set.

12. The non-invasive control system of claim 7, wherein the reinforcement learning agent noninvasively stimulates a brain area responsible for the user's learning and inference by providing knowledge content based on the learning mechanism of the user and an interaction.
